(19) United States
(12) Patent Application Publication
(10) Pub. No.: US 2006/0060572 A1
(43) Pub. Date: Mar. 23, 2006

(54) Linear weld seam with high load capacity and process for production

(76) Inventors: Wolfgang Becker, Ulm (DE); Jens Buehler, Stuttgart (DE); Klaus Goth, Sindelfingen (DE); Claus-Dieter Reiniger, Remshalden (DE); Daniel Zauner, Ballendorf (DE)

Correspondence Address: PENDORF & CUTLIFF, 5111 Memorial Highway, Tampa, FL, 33634-7356, US

(21) Appl. No.: 11/225,581

(22) Filed: Sep. 13, 2005

(30) Foreign Application Priority Data
Sep. 17, 2004 (DE) 102004045104.4-45

(51) Int. Cl. B23K 26/00

(52) U.S. Cl. 219/121.64

(57) ABSTRACT

For increasing the load bearing capacity of spot-like weld seams for producing a durable joint between at least two components, it is known to lengthen this linearly, that is, to weld with a longitudinal orientation extending more than 30 mm. Such linear weld seams, however, do not endure high loads. The task of the present invention comprises providing linear weld seams with increased load bearing capacity and a process for their production. This task is solved by a process specifically for increasing the load bearing capacity of a linear weld seam for producing a durable joint between at least two components, wherein the location with the highest probability of a weld seam break is determined and then, at this location, a discontinuity is introduced into the weld seam, in such a manner that the tangent of the connecting line exhibits an angle of 15° or more.

### BACKGROUND OF THE INVENTION

1. Field of the Invention

The invention concerns a linear weld seam with high load capacity or toughness, and a process for production thereof.

2. Related Art of the Invention

For increasing the load capacity or toughness of spot weld seams in order to produce a durable connection between at least two components, it is known to lengthen these linearly, that is, to extend the length of the weld to more than 30 mm. Such linear weld seams, however, are not able to endure high loads.

### SUMMARY OF THE INVENTION

The task of the present invention concerns the providing of linear weld seams which are capable of accepting high load and a process for their production.

The invention is set forth in greater detail below with regard to the process to be provided and with regard to the weld seam to be provided.

With regard to the process to be provided for the targeted increase in the load bearing ability or toughness of a linear-like weld seam for production of a durable connection between at least two components, the task is inventively solved thereby, that the location with the highest probability of a weld seam rupture is determined, and that at this determined location a discontinuity is introduced in the weld seam, such that the tangent of the connecting line exhibits an angle (intersection angle) of 15° or more.

Therein, the connecting line between the at least two components is defined as the centerline or axis of the contact surface of the at least two components, which is formed on the one hand by the weld seam and on the other hand by the second, discontinuous running, durable joint of the components.

The location of the highest probability of a seam rupture can be empirically determined or can be determined by simulation of the expected load conditions of the linear weld seam by known methods (for example, load and brake simulation based on FEM structure calculations).

Depending upon the type of the loads to be expected and the design of the linear weld seam, it has been found that the location with the highest probability of a seam rupture could occur at the end of the weld seam just as well as in the middle of the seam progression. As a consequence, the discontinuity is introduced; depending upon the type of the load to be expected and the design of the linear weld seam, either on one weld seam end or some were at a predetermined point along the extent of the weld seam.

Surprisingly, it has been found that the tangents of the connecting line need not be perpendicular relative to each other, in order to ensure a significant increase in the load bearing capacity of the joint. Even with an angle of 15°, a substantial increase in the load bearing ability occurs, even better, however, is an angle of greater than 45°.

In one advantageous embodiment of the inventive process, the discontinuity is produced in the form of a second weld seam provided at an angle relative to the first weld seam, wherein with regard to time and control technology, it is particularly advantageous when both are welded in one continuous movement. Alternatively to this, both weld seams can, however, be produced time independent from each other, wherein the time sequence does not play any role.

Preferably, the second weld seam exhibits a length of at least the triple of the breadth of the first weld seam.

Surprisingly, it has been found that the weld seams need not exhibit any axis of symmetry and need not cross themselves, in order to impart a significant increase in the load bearing capacity of the joint. Even a one-sided tilting of the connecting line of the two weld seams by 15° already imparts a substantial increase in load bearing capacity.

In one advantageous embodiment of the inventive process, the weld seam is produced by welding using a laser beam, whereby durable connections can be produced with high precision very rapidly. Other types of welding, for example resistance welding, are likewise employable.

It is particularly advantageous when the laser beam is moved over the surface by means of a scanner device. A scanner device is a particularly rapid and flexible beam deflection device, for example a mirror system (of at least one single- or multi-axis controllable pivotable mirror) or alternatively acusto-optic modulators. Thereby, the time required for repositioning of the laser beam during the introduction of the discontinuities disappears almost completely. Therewith, a highly efficient utilization of the laser system is made possible.

In one alternative advantageous embodiment of the inventive process, the discontinuity is produced in the form of a second joint connection, preferably brought about by a deformation or reshaping, for example by clinching, stamp riveting or seam clinching, of which the connecting line of the two components is provided angled to the connecting line of the weld seam. Preferably, first the discontinuity is produced, and thereafter, the weld seam is applied up to, or over it.

In the following, the inventive process and the weld seams are described in greater detail on the basis of six illustrative embodiments and associated figures:

### BRIEF DESCRIPTION OF THE DRAWINGS

Therein there is shown:

FIG. 1 Asymmetric welded discontinuity on a weld seam

FIG. 2 Symmetric weld seam discontinuity at a point predicted to be at risk of breakage along the weld seam with a simple cross-over

FIG. 3 Symmetric welded discontinuity at a point predicted to be at risk of breakage along the weld seam with double crossing.

FIG. 4 Asymmetric welded discontinuity about a point predicted to be at risk of breakage along the weld seam without crossing

FIG. 5 Asymmetric welded discontinuity in a weld seam at a point predicted to be at risk of breakage along the weld seam with a simple crossing

FIG. 6 Asymmetric clinched discontinuity in a weld seam at a point predicted to be at risk of breakage along the weld seam

### DETAILED DESCRIPTION OF THE INVENTION

According to a first illustrative embodiment, over a longer period of time a large number of respectively two sheets of steel to be joined to each other are joined by means of a laser scanner with a straight weld seam of 20 mm length and respectively subject to a series of various loads, until a break in the weld seam occurs. The progression of the weld seam break is observed and the location of the initiation of the weld seam breakage is respectively determined. By means of a statistical evaluation the most frequently occurring location is determined. This location is considered to be the empirically determined location with the highest probability of a weld seam breakage.

According to this first illustrative embodiment, one end of the weld seam is determined as being the location with the highest probability of a weld seam breakage.

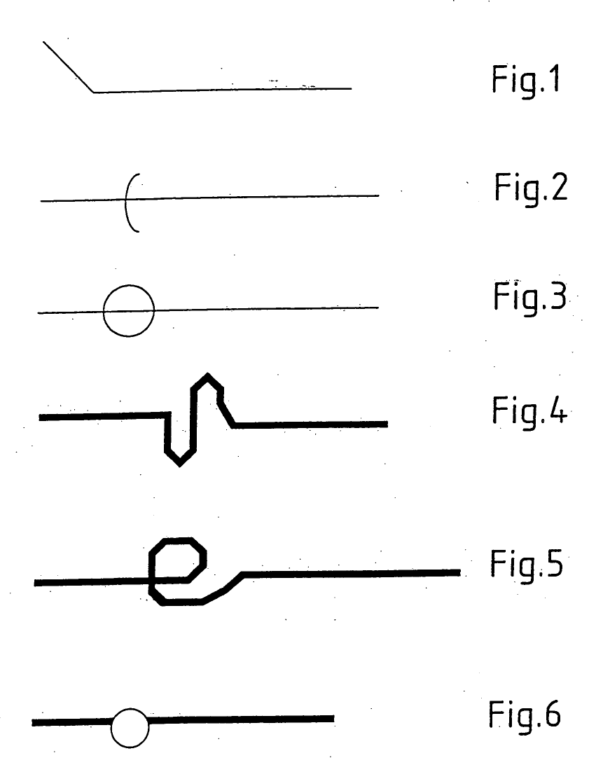

Two similar steel sheets to be joined to each other are joined by means of a laser scanner with the same weld seam of 20 mm length, wherein, on the end with the greatest risk of weld seam breakage, in one continuous movement, the laser scanner is moved to produce a second laser weld seam of 5 mm in length, in such a manner that the tangents of the connecting line exhibit an angle of approximately 45°. The shape of the connecting line of the two laser weld seams is shown in FIG. 1.

Such a linear weld seam with discontinuity in accordance with the invention exhibits an increase in load bearing capacity of more than 30%.

According to a second illustrative embodiment, the fault or breakage of a 500 mm long weld seam is determined, which seam joins two curved components which are subjected to strong vibrations. This time the breakage begins in the middle of the run of the weld seam.

Relief is provided in accordance with FIG. 2 by the introduction of a symmetric welded discontinuity, which crosses the original weld seam at the point with the danger of breakage. The load accepting ability of the weld seam is even further increased by the introduction of a symmetric welded discontinuity according to FIG. 3, which twice crosses the original weld seam at the point at risk of breakage. Similarly tough is a weld seam with a symmetric welded discontinuity at the point in danger of breakage, without crossing, according to FIG. 4. Somewhat weaker is a weld seam with asymmetric welded discontinuity with a simple cross-over at the point in danger of breaking according to FIG. 5.

According to a sixth embodiment involving two curved components, which are subjected to strong vibrations, first the point in danger of breakage is clinched and then the linear weld seam is passed there-over, as shown in FIG. 6.

The inventive weld seam and the inventive process for its production demonstrate themselves in the illustrative embodiments of the above described examples as particularly suited for the production of conventional joints between components which are at least occasionally subjected to strong loads, in particular for the laser welding of steel sheets such as for example body sheet metal subjected to vibration loads.

In accordance with the invention, substantial advantages or improvements with regard to the load bearing capacity can be produced. This, for its part, brings about a reduction in weight, as well as savings in space and costs.

The invention is not limited to the above described illustrative embodiments, but rather can be applied broadly.

It is thus also conceivable to provide multiple discontinuities at different locations at risk of breaking in the linear weld seam.

1. Process specifically for increasing the load bearing capacity of a linear weld seam for producing a durable joint between at least two components, thereby characterized, that the location along the weld seam with the highest probability of a weld seam break is determined, that at this location a discontinuity is introduced into the weld seam, in such a manner that the tangents at the connecting line exhibit an angle of 15° or more.

2. Process according to claim 1, thereby characterized, that the discontinuity is produced in the form of
a second weld seam angled with respect to the first weld seam, wherein preferably both are welded in a continuous movement, or
a second joint connection, preferably a clinch connection, of which the connecting line of the two components is angled relative to the connecting line of the weld seam.

3. Linear weld seam with increased load bearing capacity for production of a durable joint between at least two components, thereby characterized, that the weld seam exhibits a discontinuity at the location of the highest probability of a weld seam break, in such a manner that the tangents of the connecting lines exhibit an angle of 15° or more.

4. Linear weld seam according to claim 3, thereby characterized, that the discontinuity exists in the form of a second weld seam provided angled relative to the first weld seam or
a second joint connection, preferably a clinch connection, of which the connecting line of the two components is angled relative to the connecting line of the weld seam.
